(19) United States
(12) Patent Application Publication
(10) Pub. No.: US 2012/0154673 A1
(43) Pub. Date: Jun. 21, 2012

(54) Camera module

(75) Inventor: Joon Hyuk Han, Hwaseong (KR)

(73) Assignee: SAMSUNG ELECTRO-MECHANICS CO., LTD., Suwon (KR)

(21) Appl. No.: 13/064,154

(22) Filed: Mar. 8, 2011

(30) Foreign Application Priority Data
Dec. 17, 2010 (KR) 10-2010-0130320

(51) Int. Cl. H04N 5/225

(52) U.S. Cl. 348/374; 348/E05.027

(57) ABSTRACT

There is provided a camera module, including: a housing having a reception space formed in a side thereof; an image sensor unit mounted in the housing; and a passive element package mounted in the reception space and connected to the image sensor unit.

### CROSS-REFERENCE TO RELATED APPLICATIONS

This application claims the priority of Korean Patent Application No. 10-2010-0130320 filed on Dec. 17, 2010, in the Korean Intellectual Property Office, the disclosure of which is incorporated herein by reference.

### BACKGROUND OF THE INVENTION

1. Field of the Invention

The present invention relates to a camera module, and more particularly, a camera module capable of the further miniaturization of the camera module using an internal space of the camera module.

2. Description of the Related Art

In accordance with the development of technology, the functions of electronic devices have increasingly improved, while electronic components have been miniaturized. In addition, electronic devices that have previously performed only a single function have been developed to perform additional functions.

A mobile phone is an example of these electronic devices. Since the main purpose of a mobile phone has been wireless communication, a mobile phone according to the related art has included only a call function. However, in accordance with the demand of users, and in order to improve the functionality of a product, a recent mobile phone has included a camera function as well as the call function.

A camera module mounted in the mobile phone has a somewhat degraded function, but has a smaller size, as compared to a camera module used in a digital camera. However, as the demand of customers for more functionality in the mobile phone has increased, the demand for the miniaturization of the camera module thereof has correspondingly increased.

In addition, the development of a camera module capable of being easily mounted in a mobile phone, while not causing a change in the circuitry of a circuit board mounted in the mobile phone, has also been urgently demanded.

### SUMMARY OF THE INVENTION

An aspect of the present invention provides a camera module capable of being easily mounted in a portable electronic device, while being capable of being miniaturized.

According to an aspect of the present invention, there is provided a camera module, including: a housing having a reception space formed in a side thereof; an image sensor unit mounted in the housing; and a passive element package mounted in the reception space and connected to the image sensor unit.

The reception space may be opened to the outside of the housing.

The reception space may be provided with a pair of grooves into which the passive element package is inserted.

The camera module may further include a cover member closing the reception space.

The passive element package may be directly mounted on the image sensor unit.

The passive element package may be directly connected to a solder ball or a connecting pad of the image sensor unit.

The housing may include a fixing unit fixing a position of the passive element package.

The fixing unit may be a protrusion protruding toward the passive element package, and the passive element package may be provided with a hole into which the protrusion is inserted.

The image sensor unit and the passive element package may be chip scale packages (CSPs).

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view of a camera module according to a first exemplary embodiment of the present invention;

FIG. 2 is an enlarged view of part A shown in FIG. 1;

FIG. 3 is an exploded perspective view of a camera module according to a second exemplary embodiment of the present invention; and

FIGS. 4 and 5 are perspective views showing a camera module according to a third exemplary embodiment of the present invention.

### DETAILED DESCRIPTION OF THE PREFERRED EMBODIMENT

Hereinafter, exemplary embodiments of the present invention will be described in detail with reference to the accompanying drawings.

In describing the present invention below, terms indicating components of the present invention are called in consideration of functions of each of the components. Therefore, these terms should not be interpreted as limiting technical components of the present invention.

### First Exemplary Embodiment

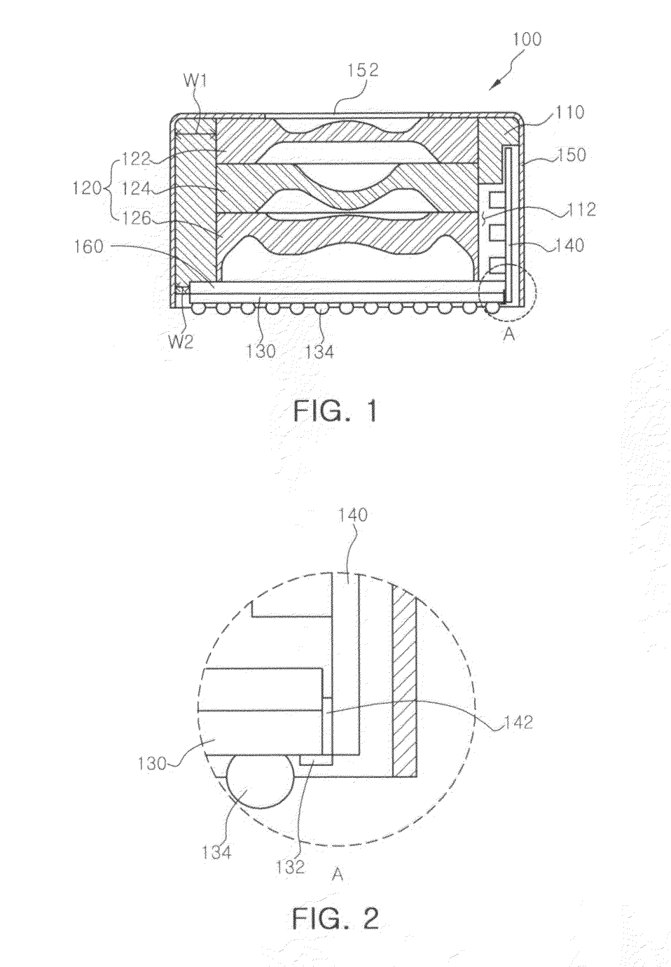

FIG. 1 is a cross-sectional view of a camera module according to a first exemplary embodiment of the present invention, and FIG. 2 is an enlarged view of part A shown in FIG. 1. A camera module according to a first exemplary embodiment of the present invention will be described with reference to FIGS. 1 and 2.

A camera module 100 according to the exemplary embodiment may include a housing 110, a lens unit 120, an image sensor unit 130, and a passive element package 140, and may selectively further include a cover member 150.

The housing 110 has a receiving space in which components configuring the camera module 110 may be mounted and including the lens unit 120 and the image sensor unit 130. The housing 110 may be manufactured to have any shape such as a square pillar shape, a circular pillar shape, or the like. The housing 110 may be manufactured by injection molding a material such as a synthetic resin or may be made of a metal material.

Meanwhile, according to the exemplary embodiment, a reception space 112 is formed in a side of the housing 110. The reception space 112 is connected to the receiving space having the image sensor unit 130 mounted therein. The reception space 112 is formed to be closest to the space having the image sensor unit 130 mounted therein.

Generally, a wall thickness w1 of the portion at which the lens unit 120 is mounted in the housing 110 is thicker than a wall thickness w2 of the portion at which the image sensor unit 130 is mounted in the housing 110. Accordingly, a wall of the portion at which the lens unit 120 is mounted may be used as the reception space 112 according to the exemplary embodiment of the present invention.

All of electronic components (for example, the passive element package 140) required for the camera module 110 may be integrated within the housing 110 through the space usage. Therefore, the camera module 100 may be miniaturized and it is unnecessary to mount the electronic components required for the camera module 100 on a main substrate (Herein, the main substrate means the substrate of a mother product (for example, a mobile phone) in which the camera module will be mounted). Therefore, according to the exemplary embodiment, space efficiency of the main substrate may be increased through the miniaturization of the camera module 100.

The lens unit 120 is mounted in an upper portion of the housing 110. The lens unit 120 collects light reflected on a subject to the image sensor unit 130. To this end, the lens unit 120 is configured of a plurality of lenses 122, 124 and 126. A first lens 122, a second lens 124, and a third lens 126 are disposed in a row based on an optical axis. The lens unit 130 according to the exemplary embodiment is configured of three lenses, that is, the first lens 122, the second lens 124, and the third lens 126; however, the number of the lenses may be increased or reduced according to usage or function of the camera module 110. In addition, spacers maintaining a predetermined distance among the lenses 122, 124, and 126 may be further mounted thereamong. The size of the space and whether the spacer exists or not may be changed according to optical characteristics to be achieved through the lenses 122, 124, and 126.

The image sensor unit 130 is mounted in a lower portion of the housing 110. An image of the subject is projected on the image sensor unit 130 by incident light through the lens unit 120. Herein, the image sensor unit 130 may have a chip scale package (CSP) shape for the miniaturization of the camera module 100. The image sensor unit 130 includes a first connecting pad 132 and solder balls 134. The first connecting pad 132 is mounted at an edge of the image sensor unit 130. The first connecting pad 132 is used for being connected to a compact electronic component. The solder balls 134 are mounted under the image sensor unit 130, while having a predetermine interval therebetween. The solder balls 134 are used for connecting the image sensor unit 130 to the subsrate. However, in some cases, the solder balls 134 may be used for connecting the image sensor unit 130 to other electronic components.

The image sensor unit 130 may have an infrared (IR) filter 160 mounted thereon in order to remove noise due to an infrared light. The IR filter 160 may be omitted. In some cases, the IR filter 160 may be attached to or coated directly onto the image sensor unit 130.

The passive element package 140 is mounted in the reception space 112 of the housing 110. The passive element package 140 includes a passive element required for the image sensor unit 130. The passive element package 140 may have the CSP shape capable of minimizing the size of the camera module. In this shape, the size of the passive element package is substantially the same as that of the passive element mounted on the substrate, such that the passive element package may be very easily connected to other electronic components. That is, the passive element package 140 having the CSP shape may be directly connected to the image sensor unit 130. FIG. 2 shows a connection form between the passive element package 140 and the image sensor unit 130.

The passive element package 140 includes a second connecting pad 142. The passive element package 140 is mounted to be substantially perpendicular to the image sensor unit 130, and is be in contact with at least one side of the image sensor unit 130. Each of contact surfaces between the passive element package 140 and the image sensor unit 130 are provided with the second connecting pad 142 and the first connecting pad 132. Accordingly, the passive element package 140 and the image sensor unit 130 are connected to each other through the connection between these connecting pads 142 and 132. In the case in which the first connecting pad 132 is not formed on the image sensor unit 130, the passive element package 140 and the image sensor unit 130 may be connected to each other through connection between the second connecting pad 142 and the solder ball 134.

According to the exemplary embodiment of the above-mentioned structure, separate connectors do not need to be mounted on the image sensor unit 130 and the passive element package 140, whereby the image sensor unit 130 and the passive element package 140 may be further miniaturized. In addition, the camera module 100 may be further miniaturized through the miniaturization of the image sensor unit 130 and the passive element package 140.

The cover member 150 has a size capable of completely receiving the housing 110. The cover member 150 has the housing received therein to protect the housing 110 and the components mounted within the housing from external impacts. An upper portion of the cover member 150 is provided with a hole 152 so that light is incident on the lens unit 120. The cover member 150 may be omitted according to a material and a shape of the housing 110.

According to the exemplary embodiment configured as described above, the passive element package 140 is received in the spare space of the housing 110, whereby the entire size of the camera module 100 may be reduced.

In addition, according to the exemplary embodiment, since the electronic components required during operation of the camera module may not be mounted on the main substrate, a usable area of the main substrate may be increased and the size of the main substrate may be reduced.

### Second Exemplary Embodiment

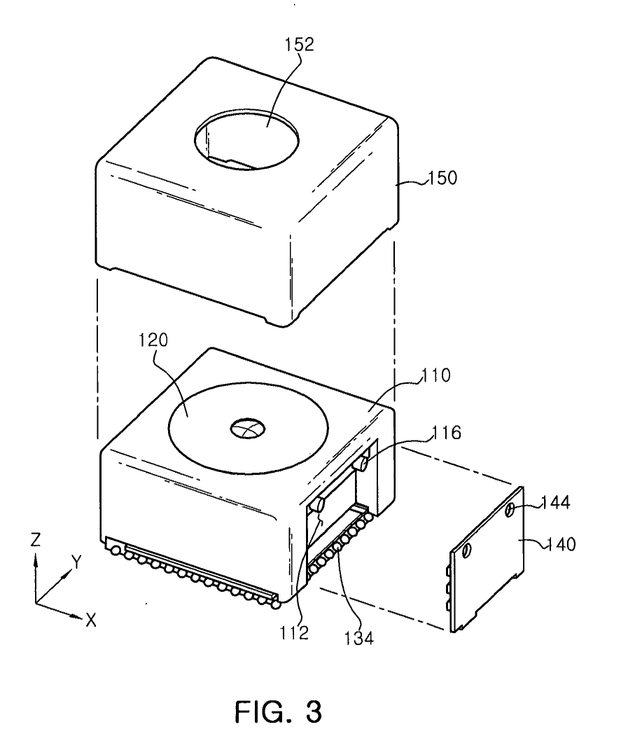

FIG. 3 is an exploded perspective view of a camera module according to a second exemplary embodiment of the present invention. Hereinafter, a camera module according to a second exemplary embodiment of the present invention will be described with reference to FIG. 3. A camera module 100 according to a second exemplary embodiment of the present invention is different from the above-mentioned embodiment in terms of a fixing structure of the passive element package 140. For reference, in the present exemplary embodiment, the same reference numerals will be used to describe the same components as the components in the above-mentioned exemplary embodiment. A detailed description of the components will be omitted.

The camera module 100 according to the second exemplary embodiment of the present invention includes fixing units stably positioning and fixing the passive element package 140. The fixing units according to the exemplary embodiment are protrusions 116 formed in the reception space 112 and holes 144 formed in the passive element package 140.

The protrusion 116 is formed in the reception space 112. The protrusion 116 is extended to be enlongated toward a direction (an X axis direction) in which the passive element package 140 is inserted thereinto. The protrusion 116 is inserted into the hole 144 of the passive element package 140 to fix the passive element package 140. At least two protrusions 116 may be provided in order to firmly fix a position of the passive element package 140. The position of the protrusion 116 formed in the reception space 112 may be changed according to the passive element package 140.

The holes 144 are formed in the passive element package 140. The size of the hole 144 may be substantially the same as a cross section of the protrusion 116 or may be larger than the cross section of the protrusion 116 so that the passive element package 140 may be easily inserted into the protrusion 116. The hole 144 is formed at a position corresponding to the protrusion 116 when the passive element package 140 has been mounted in the reception space 112. The hole 144 may be formed at an empty space (a space in which the electronic components are not mounted) of the passive element package 140.

Meanwhile, when the size of the hole 144 is larger than the cross section of the protrusion 116, the fixing effect of the passive element package 140 due to the protrusion 116 and the hole 144 is deteriorated. In order to solve the limitation, the protrusion 116 may be formed to have a thickness thicker toward an optical axis (that is, a-X axis). As the passive element package 140 approaches the image sensor unit 130, the protrusion 116 having the gradually increasing cross section area may be firmly coupled to the hole 144, thereby further securely fixing the position of the passive element package 140.

According to the exemplary embodiment, the passive element package 140 is fixed by the protrusion 116 and the hole 144, whereby the passive element package 140 and the image sensor unit 130 may be firmly connected to each other.

Meanwhile, the outside of the reception space 112 is closed by the cover member 150, such that although a separate cover is not provided, the passive element package 140 may be protected from external impacts.

### Third Exemplary Embodiment

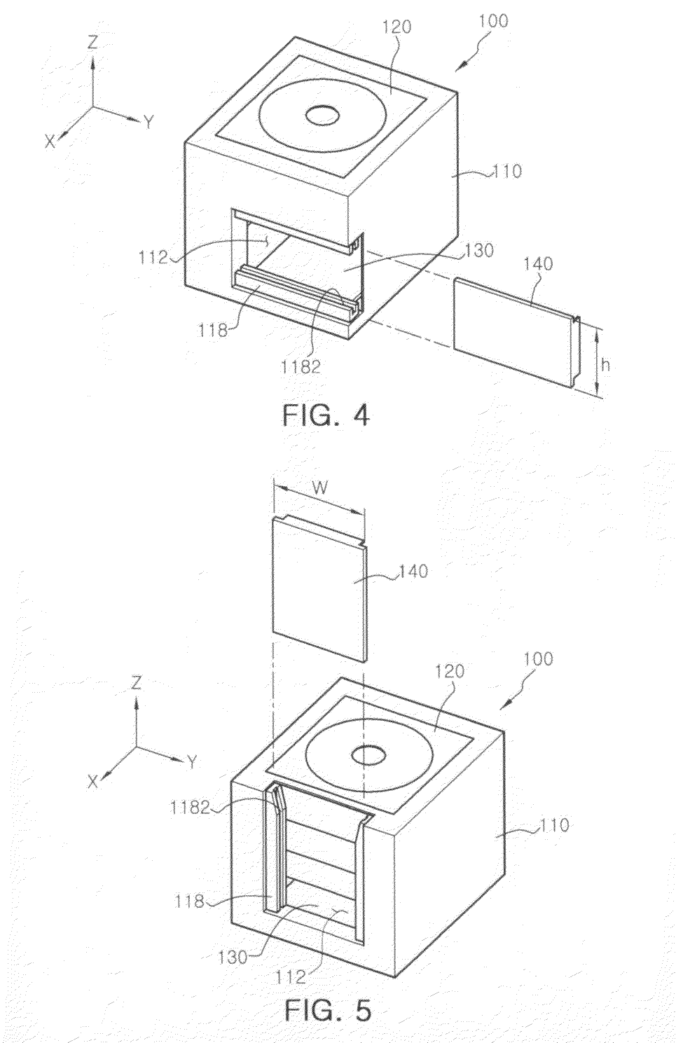

FIGS. 4 and 5 are perspective views showing a camera module according to a third exemplary embodiment of the present invention. A camera module according to a third exemplary embodiment of the present invention will be described with reference to FIGS. 4 and 5. The camera module 100 according to the third exemplary embodiment of the present invention is different from the above-mentioned embodiments in terms of the fixing structure of a passive element package 140. For reference, in this exemplary embodiment, the same reference numerals will be used to describe the same components as the components in the above-mentioned exemplary embodiments. A detailed description of the components will be omitted.

The camera module 100 according to the exemplary embodiment includes a pair of guide members 118 capable of fixing the passive element package 140.

Similar to the above-mentioned exemplary embodiments, the housing 110 has a reception space 112 which is opened to the image sensor unit 130. However, the reception space 112 according to the exemplary embodiment is opened laterally or upwardly in the housing 110 (See FIGS. 4 and 5).

The guide members 118 are mounted along the opened direction of the reception space 112. For example, in FIG. 4 in which the reception space 112 is opened in a Y axis direction, the guide members 118 are mounted on an upper surface and a lower surface of the reception space 112 along the Y axis direction. Further, in FIG. 5 in which the reception space 112 is opened in a Z axis direction, the guide members 118 are mounted on both sides of the reception space 112 along the Z axis direction.

The guide members 118 have grooves 1182 into which the passive element package is inserted. A distance between the grooves 1182 formed in the guide members 118 opposite to each other may be the same as a height h or a width W of the passive element package or may be larger than the height h or the width W thereof. The distance between the grooves 1182 may become narrower toward a connection point between the passive element package 140 and the image sensor unit 130. This structure may maximize the fixing effect of the passive element package 140 through the grooves 1182.

According to the exemplary embodiment configured as described above, the passive element package 140 may be mounted in the reception space 112 in a sliding manner, whereby the passive element package may be easily mounted.

As set forth above, according to the exemplary embodiments of the present invention, the camera module uses a spare space between the lens unit and the image sensor package, whereby the camera module may be further miniaturized.

In addition, according to the exemplary embodiments of the present invention, the structure in which all of the circuits and the elements required for the camera module are integrated in the camera module is provided, whereby a configuration of the electronic device having the camera module mounted therein may be simplified. Therefore, according to the exemplary embodiments of the present invention, the miniaturization of the electronic device having the camera module mounted therein may be promoted.

While the present invention has been shown and described in connection with the exemplary embodiments, it will be apparent to those skilled in the art that modifications and variations can be made without departing from the spirit and scope of the invention as defined by the appended claims.

What is claimed is:

1. A camera module, comprising:
a housing having a reception space formed in a side thereof;
an image sensor unit mounted in the housing; and
a passive element package mounted in the reception space and connected to the image sensor unit.

2. The camera module of claim 1, wherein the reception space is opened to an outside of the housing.

3. The camera module of claim 1, wherein the reception space is provided with a pair of grooves into which the passive element package is inserted.

4. The camera module of claim 1, further comprising a cover member closing the reception space.

5. The camera module of claim 1, wherein the passive element package is directly mounted on the image sensor unit.

6. The camera module of claim 1, wherein the passive element package is directly connected to a solder ball or a connecting pad of the image sensor unit.

7. The camera module of claim 1, wherein the housing includes a fixing unit fixing a position of the passive element package.

8. The camera module of claim 7, wherein the fixing unit is a protrusion protruding toward the passive element package, and
the passive element package is provided with a hole into which the protrusion is inserted.

9. The camera module of claim 1, wherein the image sensor unit and the passive element package are chip scale packages (CSPs).
